(19) United States
(12) Patent Application Publication
(10) Pub. No.: US 2016/0099600 A1
(43) Pub. Date: Apr. 7, 2016

(54) WIRELESS CHARGING METHOD AND WIRELESS CHARGING SYSTEM

(71) Applicant: Primax Electronics Ltd., Neihu (TW)

(72) Inventors: YUNG-HSIEN HO, Neihu (TW); HUNG-WEI CHIU, Neihu (TW); CHUN-HAO LO, Neihu (TW)

(21) Appl. No.: 14/558,382

(22) Filed: Dec. 2, 2014

(30) Foreign Application Priority Data
Oct. 3, 2014 (TW) 103134624

(51) Int. Cl. H02J 7/02; H02J 5/00; H02J 7/00

(52) U.S. Cl. CPC H02J 7/025; H02J 7/007; H02J 5/005

(57) ABSTRACT

A wireless charging method and a wireless charging system are provided. The wireless charging system includes plural wireless power transmitting devices and a wireless power receiving device. The plural wireless power transmitting devices generate plural energy fields. The energy fields contain plural identification signals, respectively. After the identification signals are decoded, the wireless power receiving device recognizes the plural wireless power transmitting devices corresponding to the plural identification signals. The wireless power receiving device is in wireless connection with the most appropriate wireless power transmitting device to perform the wireless charging task. Consequently, the wireless charging efficiency is enhanced.

### FIELD OF THE INVENTION

The present invention relates to a wireless charging method and a wireless charging system, and more particularly to a wireless charging method and a wireless charging system having identification signals in energy fields.

### BACKGROUND OF THE INVENTION

Nowadays, most electronic devices may be charged by a wired charging technology or a wireless charging technology. In case that the electronic device is charged by the wired charging technology, a charging slot of the electronic device is connected with a connecting terminal of a charger to acquire electric power. In case that the electronic device is charged by the wireless charging technology, the electronic device receives a wireless signal and converts the wireless signal into electric power. Although the wired charging technology is very popular, there are still some drawbacks. For example, after a long use period, the charging slot of the electronic device or the connecting terminal of the charger is possibly suffered from deformation. The deformation may result in a poor contact between the charging slot of the electronic device and the connecting terminal of the charger. Under this circumstance, the electronic device cannot be successfully charged by the wired charging technology. For solving the drawbacks of the wired charging technology, some electronic devices are charged by the wireless charging technology.

For performing the wireless charging operation, the electronic device has to be in wireless connection with a corresponding wireless power transmitting device, and the electronic device acquires the electric power from the wireless power transmitting device according to magnetic induction. In accordance with a first conventional wireless charging method, a first coil is disposed within the electronic device and a second coil is disposed within the wireless power transmitting device. Through the first coil and the second coil, the wireless connection between the electronic device and the wireless power transmitting device is established. Consequently, the electronic device and the wireless power transmitting device are in wireless connection with each other in order to transmit and receive the electric power. Moreover, the electric energy may be transmitted and received through the first coil and the second coil. After the electronic device is in wireless connection with the wireless power transmitting device, the electronic device may request the wireless power transmitting device to transmit the electric energy. Consequently, the electric power is converted into an energy field (e.g. a magnetic field) by the second coil of the wireless power transmitting device. By receiving the energy field, the first coil of the electronic device acquires the electric energy.

In the first conventional wireless charging method, the first coil and the second coil have both the functions of wireless communication and energy transmission. In other words, while the wireless communication and the energy transmission between the wireless power transmitting device and the electronic device are implemented, the wireless power transmitting device may decode a wireless communication signal according to a loading condition of the electronic device. However, depending on the loading condition of the electronic device, the intensity of the signal which is sent back is different. For example, the intensity of the signal in the full loading condition and the intensity of the signal in the light loading condition are largely different. Consequently, the wireless power transmitting device cannot decode the wireless communication signal through a single decoding program and a single hardware component. For solving the above drawbacks, a second conventional wireless charging method is disclosed. In the second conventional wireless charging method, two separate components are responsible for implementing the wireless communication task and the energy transmission task, respectively.

Please refer to FIG. 1. FIG. 1 is a schematic functional block diagram illustrating a wireless charging system using the second conventional wireless charging method. As shown in FIG. 1, the wireless charging system 100 comprises a wireless power transmitting device 110 and a wireless power receiving device 120. The wireless power transmitting device 110 comprises a first wireless communication module 111, an energy supply module 112 and a first controller 113. The wireless power receiving device 120 comprises a second wireless communication module 121, an energy conversion module 122, a battery 123 and a second controller 124. The first wireless communication module 111 and the second wireless communication module 121 are general wireless communication modules such as Bluetooth communication module. The energy supply module 112 and the energy conversion module 122 are coils. The wireless communication between the wireless power transmitting device 110 and the wireless power receiving device 120 may be implemented through the first wireless communication module 111 and the second wireless communication module 121, and the energy transmission between the wireless power transmitting device 110 and the wireless power receiving device 120 may be implemented through the energy supply module 112 and the energy conversion module 122. Consequently, the wireless power transmitting device 110 can simultaneously implement the wireless communication task and the wireless charging task. In addition, since the wireless power transmitting device can decode the wireless communication signal more easily, the stability of wirelessly charging the wireless power receiving device 120 is enhanced.

The operations of the wireless charging system 100 using the second conventional wireless charging method will be illustrated as follows. The first wireless communication module 111 and the energy supply module 112 are electrically connected with the first controller 113. The first wireless communication module 111 is used for transmitting and receiving a wireless signal. According to the wireless signal, the first wireless communication module 111 is in wireless connection with other wireless communication modules. The energy supply module 112 is used for converting the electric power into an energy field (e.g. a magnetic field). By receiving the energy field, the wireless power receiving device 120 is wirelessly charged.

The second wireless communication module 121, the energy conversion module 122 and the battery 123 are electrically connected with the second controller 124. The second wireless communication module 121 is used for transmitting and receiving the wireless signal. According to the wireless signal, the second wireless communication module 121 is in wireless connection with other wireless communication modules. The energy conversion module 122 is used for receiving the energy field and converting the electric field into the electric power. An example of the battery 123 is a chargeable battery such as a nickel-metal hydride battery or a lithium ion battery. The battery 123 is used for receiving and storing the electric power and providing the electric power to other components of the wireless power receiving device 120. In this embodiment, the electric power acquired by the wireless power receiving device 120 through the conversion of the electric power is stored in the battery 123. It is noted that the wireless power receiving device 120 is not restricted to have the battery 123. For example, some of the commercially-available wireless power receiving devices have no the built-in batteries. Under this circumstance, the electric power acquired by the wireless power receiving device is directly transmitted and provided to other components of the energy conversion module. Consequently, it is not necessary to additionally install a battery for storing the electric power.

In principle, if the second wireless communication module 121 of the wireless power receiving device 120 is located within an effective communication range of the first wireless communication module 111 of the wireless power transmitting device 110 and the energy conversion module 122 of the wireless power receiving device 120 is located within the energy field of the energy supply module 112 of the wireless power receiving device 120, the wireless power receiving device 120 can be successfully in wireless connection with the wireless power transmitting device 110 and acquire the electric power from the energy field of the wireless power transmitting device 110.

The steps of a wireless charging process will be illustrated as follows. Firstly, the first wireless communication module 111 of the wireless power transmitting device 110 is in wireless connection with the second wireless communication module 121 of the wireless power receiving device 120. Consequently, the pairing relation between the wireless power transmitting device 110 and the wireless power receiving device 120 is established. Then, the second controller 124 of the wireless power receiving device 120 allows the energy conversion module 122 to receive the energy field from the energy supply module 112 and covert the energy field into the electric power. The electric power is further stored in the battery 123. Consequently, the wireless charging task of the wireless power receiving device 120 is started.

Although the second conventional wireless charging method can solve the drawbacks of the first conventional wireless charging method, there are still some drawbacks. In particular, although the signal transmission between the first wireless communication module 111 and the second wireless communication module 121 and the signal transmission between the energy supply module 112 and the energy conversion module 122 are implemented in a wireless transmission manner, the effective communication ranges of the first wireless communication module 111 and the second wireless communication module 121 and the effective power transmission ranges of the energy supply module 112 and the energy conversion module 122 are not identical. For example, the Bluetooth transmission ranges of the first wireless communication module 111 and the second wireless communication module 121 are about 10 meters. However, the effective distance between the energy supply module 112 and the energy conversion module 122 is smaller than the Bluetooth transmission ranges. For example, according to an A4WP (Alliance for Wireless Power) protocol, the effective distance between the energy supply module 112 and the energy conversion module 122 is appropriately in the range between 30 centimeters to 9 meters.

As mentioned above, the effective power transmission ranges of the energy supply module 112 and the energy conversion module 122 are smaller than the effective communication ranges of the first wireless communication module 111 and the second wireless communication module 121 according to the current charging standards. If the distance between the wireless power receiving device 120 and the wireless power transmitting device 110 is too far, the wireless power receiving device 120 is possibly located within the effective communication range of the wireless power transmitting device 110, but the wireless power receiving device 120 is not located within the effective power transmission range of the wireless power transmitting device 110. Under this circumstance, the wireless power receiving device 120 is able to be successfully in wireless connection with the wireless power transmitting device 110. However, the wireless power receiving device 120 cannot acquire the electric power from the wireless power transmitting device 110 because the wireless power receiving device 120 is not located within the effective power transmission range. Meanwhile, the wireless power receiving device 120 cannot be wirelessly charged.

In some situations, plural wireless power transmitting devices may be located near one wireless power receiving device. FIG. 2 is a schematic functional block diagram illustrating another wireless charging system using the second conventional wireless charging method. As shown in FIG. 2, the wireless charging system 200 comprises a first wireless power transmitting device 210, a second wireless power transmitting device 220 and a wireless power receiving device 230. The first wireless power transmitting device 210 comprises a first wireless communication module 211 and a first energy supply module 212. The second wireless power transmitting device 220 comprises a second wireless communication module 221 and a second energy supply module 222. The wireless power receiving device 230 comprises a third wireless communication module 231 and an energy conversion module 232.

The first wireless communication module 211 of the first wireless power transmitting device 210 and the second wireless communication module 221 of the second wireless power transmitting device 220 may be in wireless connection with the third wireless communication module 231 of the wireless power receiving device 230. The first energy supply module 212 of the first wireless power transmitting device 210 and the second energy supply module 222 of the second wireless power transmitting device 220 are used for converting electric power into energy fields. The energy conversion module 232 of the wireless power receiving device 230 may receive the energy field and covert the energy field into electric power. The operations of the first wireless power transmitting device 210 and the second wireless power transmitting device 220 are similar to those of the wireless power transmitting device 110 of FIG. 1, and the operations of the wireless power receiving device 230 are similar to those of the wireless power receiving device 120 of FIG. 1. Consequently, the operations of the components of the first wireless power transmitting device 210, the second wireless power transmitting device 220 and the wireless power receiving device 230 are not redundantly described herein.

The first wireless communication module 211 of the first wireless power transmitting device 210 has an effective communication range R1. The second wireless communication module 221 of the second wireless power transmitting device 220 has an effective communication range R2. Moreover, the first energy supply module 212 of the first wireless power transmitting device 210 has an effective power transmission range R3, and the second energy supply module 222 of the second wireless power transmitting device 220 has an effective power transmission range R4.

If the wireless power receiving device 230 is located within the effective communication range R1 of the first wireless power transmitting device 210, the wireless power receiving device 230 may be in communication with the first wireless power transmitting device 210. If the wireless power receiving device 230 is located within the effective communication range R2 of the second wireless power transmitting device 220, the wireless power receiving device 230 may be in communication with the second wireless power transmitting device 220. Moreover, if the wireless power receiving device 230 is located within the effective power transmission range R3 of the first wireless power transmitting device 210, the wireless power receiving device 230 may receive the energy field from the first wireless power transmitting device 210. Similarly, if the wireless power receiving device 230 is located within the effective communication range R4 of the second wireless power transmitting device 220, the wireless power receiving device 230 may receive the energy field from the second wireless power transmitting device 220. For facilitating illustration, the diameter of the effective communication range R1 of the first wireless power transmitting device 210 is equal to the diameter of the effective communication range R2 of the second wireless power transmitting device 220, and the diameter of the effective power transmission range R3 of the first energy supply module 212 is equal to the diameter of the effective communication range R4 of the second energy supply module 222.

Since the operating principles of the wireless communication and the wireless power transmission are different, the effective communication ranges of the first wireless communication module 211, the second wireless communication module 221 and the third wireless communication module 231 are wider than the effective power transmission ranges of the first energy supply module 212, the second energy supply module 222 and the energy conversion module 232. In other words, the diameter of the effective communication range R1 of the first wireless communication module 211 is larger than the diameter of the effective power transmission range R3 of the first energy supply module 212, and the diameter of the effective communication range R2 of the second wireless communication module 221 is larger than the diameter of the effective communication range R4 of the second energy supply module 222.

As shown in FIG. 2, the wireless power receiving device 230 is located within the effective communication range R1 of the first wireless power transmitting device 210, the effective communication range R2 of the second wireless power transmitting device 220 and the effective communication range R4 of the second wireless power transmitting device 220. However, the wireless power receiving device 230 is not located within the effective power transmission range R3 of the first wireless power transmitting device 210. Consequently, even if the wireless power receiving device 230 is in wireless connection with the first wireless power transmitting device 210, the wireless power receiving device 230 cannot receive the energy field from the first wireless power transmitting device 210. Under this circumstance, the wireless power receiving device 230 cannot acquire the electric power.

If the wireless power receiving device 230 is in wireless connection with the first wireless power transmitting device 210 but the wireless power receiving device 230 is unable to receive the energy field from the first wireless power transmitting device 210, the wireless power receiving device 230 will continuously request the first wireless power transmitting device 210 to increase the intensity of the energy field. Once the energy field is increased, the first energy supply module 212 of the first wireless power transmitting device 210 may convert more electric power into the energy field. In other words, the wireless charging task of the wireless power receiving device 230 cannot be successfully done. Moreover, since the first wireless power transmitting device 210 continuously consumes lot of electric power to convert the electric power into the energy field, a problem of wasting electric power occurs. Moreover, if the electric field is too strong, the human body or the nearby objects of the first wireless power transmitting device 210 may be suffered from injury or damage.

On the other hand, if the plural wireless power transmitting devices are located near the wireless power receiving device, the wireless power receiving device is unable to recognize which wireless power transmitting device is the source of the energy field and unable to judge which wireless power transmitting device is closer to the wireless power receiving device. Under this circumstance, the wireless power receiving device cannot achieve the highest wireless charging efficiency at the maximum electric energy. In other words, the wireless power receiving device cannot select the most suitable wireless power transmitting device to perform the wireless charging task.

FIG. 3 is a schematic functional block diagram illustrating another wireless charging system using the second conventional wireless charging method. In the wireless charging system 200′ of FIG. 3, the components corresponding to those of the wireless charging system 200 of FIG. 2 are designated by similar numeral references, and detailed descriptions thereof are omitted. As shown in FIG. 3, the distance between the wireless power receiving device 230′ and the first wireless power transmitting device 210′ is also larger than the distance between the wireless power receiving device 230′ and the second wireless power transmitting device 220′. However, the effective power transmission range R3 of the first wireless power transmitting device 210′ is increased, and the effective communication range R4 of the second wireless power transmitting device 220′ is increased. Consequently, the wireless power receiving device 230′ is located within both of the effective power transmission range R3 of the first wireless power transmitting device 210′ and the effective communication range R4 of the second wireless power transmitting device 220′.

In other words, the wireless power receiving device 230′ not only receives the energy field from the second wireless power transmitting device 220′ but also receives the energy field of the first wireless power transmitting device 210′. However, the wireless power receiving device 230′ is closer to the second wireless power transmitting device 220′ and farther from the first wireless power transmitting device 210′. Consequently, if the intensity of the energy field generated by the first wireless power transmitting device 210′ and the intensity of the energy field generated by the second wireless power transmitting device 220′ are identical, the wireless power receiving device 230′ can acquire more energy from the second wireless power transmitting device 220′ so as to achieve the higher wireless charging efficiency.

If the wireless power receiving device 230′ is in wireless connection with the first wireless power transmitting device 210′ and receives the energy field from the first wireless power transmitting device 210′, the wireless power receiving device 230′ will request the first wireless power transmitting device 210′ to increase the intensity of the energy field. Once the energy field is increased, the first energy supply module 212′ of the first wireless power transmitting device 210′ may convert more electric power into the energy field. In other words, the wireless charging efficiency of the wireless power receiving device 230′ is low. Moreover, since the first wireless power transmitting device 210′ continuously consumes lot of electric power to convert the electric power into the energy field, a problem of wasting electric power occurs. Moreover, if the electric field is too strong, the human body or the nearby objects of the first wireless power transmitting device 210′ may be suffered from injury or damage.

Therefore, there is a need of providing a wireless power receiving device, a wireless charging method or a wireless charging system in order to overcome the above drawbacks.

### SUMMARY OF THE INVENTION

An object of the present invention provides a wireless charging method, a wireless charging system and a wireless power receiving device for performing a wireless charging task effectively and efficiently.

In accordance with an aspect of the present invention, there is provided a wireless charging method. Firstly, a wireless power receiving device is in wireless connection with plural wireless power transmitting devices sequentially. Then, energy fields from the plural wireless power transmitting devices are received, wherein the energy fields contain plural identification signals, respectively. Then, the plural identification signals are decoded. Then, plural power consumption amounts of the corresponding energy fields are calculated. Then, the plural identification signals corresponding to the energy fields and the plural power consumption amounts are recorded. Then, the lowest power consumption amount of the plural power consumption amounts is recognized. Then, the wireless power receiving device is in wireless connection with the wireless power receiving device corresponding to the lowest power consumption amount according to the identification signal corresponding to the lowest power consumption amount, so that the wireless power receiving device is wirelessly charged by the wireless power transmitting device corresponding to the lowest power consumption amount.

In an embodiment, the identification signal is a high frequency signal or a media access control address of the corresponding wireless power transmitting device.

In accordance with another aspect of the present invention, there is provided a wireless power receiving device. The wireless power receiving device includes a wireless communication module, an energy conversion module, a decoder and a controller. The wireless communication module is in wireless connection with plural wireless power transmitting devices sequentially. The energy conversion module receives energy fields from the plural wireless power transmitting devices, wherein the energy fields contain plural identification signals, respectively. The decoder decodes the plural identification signals. The controller calculates plural power consumption amounts of the corresponding energy fields, recognizes the lowest power consumption amount of the plural power consumption amounts, and allows the wireless communication module to be in wireless connection with the wireless power transmitting device corresponding to the lowest power consumption amount according to the identification signal corresponding to the lowest power consumption amount, so that the wireless power receiving device is wirelessly charged by the wireless power transmitting device corresponding to the lowest power consumption amount.

In an embodiment, the wireless communication module is a Bluetooth communication module.

In an embodiment, the identification signal is a high frequency signal or a media access control address of the corresponding wireless power transmitting device.

In accordance with a further aspect of the present invention, there is provided a wireless power system. The wireless power system includes plural wireless power transmitting devices and a wireless power receiving device. The plural wireless power transmitting devices include plural first wireless communication modules and plural energy supply modules, respectively. The first wireless communication modules generate plural wireless communication signals, respectively. The plural energy supply modules generate plural energy fields, respectively. The energy fields contain plural identification signals, respectively. The wireless power receiving device includes a second wireless communication module, an energy conversion module, a decoder and a controller. The second wireless communication module receives the plural wireless communication signals. The second wireless communication module is in wireless connection with plural wireless power transmitting devices sequentially according to the plural wireless communication signals. The energy conversion module receives the energy fields from the plural wireless power transmitting devices. The decoder decodes the plural identification signals. The controller recognizes the plural wireless power transmitting devices corresponding to the plural identification signals and allows the second wireless communication module to be in wireless connection with the first wireless communication module of each wireless power transmitting device, so that the wireless power receiving device is wirelessly charged.

In an embodiment, the controller further calculates plural power consumption amounts of the corresponding energy fields, recognizes the lowest power consumption amount of the plural power consumption amounts, and allows the second wireless communication module to be in wireless connection with the wireless power transmitting device corresponding to the lowest power consumption amount according to the identification signal corresponding to the lowest power consumption amount, so that the wireless power receiving device is wirelessly charged by the wireless power transmitting device corresponding to the lowest power consumption amount.

In an embodiment, each of the plural wireless communication signals contains an original power supply information, and the controller calculates the power consumption amount of the corresponding energy field according to an electric quantity obtained through conversion by the energy conversion module and the original power supply information.

In an embodiment, the first wireless communication modules and the second wireless communication modules are Bluetooth communication modules.

In an embodiment, the identification signal is a high frequency signal or a media access control address of the corresponding first wireless communication module.

In an embodiment, each of the plural wireless power transmitting devices comprises a processor, wherein the processor generates the corresponding identification signal.

In an embodiment, each of the energy supply modules of the plural wireless power transmitting devices comprises a mixer. After the mixer loads the corresponding identification signal into a transmitting signal, a mixing signal is generated, wherein the energy field is generated according to the mixing signal.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a wireless charging system using the second conventional wireless charging method;

FIG. 2 is a schematic functional block diagram illustrating another wireless charging system using the second conventional wireless charging method;

FIG. 3 is a schematic functional block diagram illustrating another wireless charging system using the second conventional wireless charging method;

FIG. 4 is a schematic functional block diagram illustrating a wireless charging system according to a first embodiment of the present invention;

FIG. 5 is a flowchart of a wireless charging method according to the first embodiment of the present invention;

FIG. 6 is a schematic functional block diagram illustrating a wireless charging system according to a second embodiment of the present invention; and

FIGS. 7A and 7B are a flowchart of a wireless charging method according to the second embodiment of the present invention.

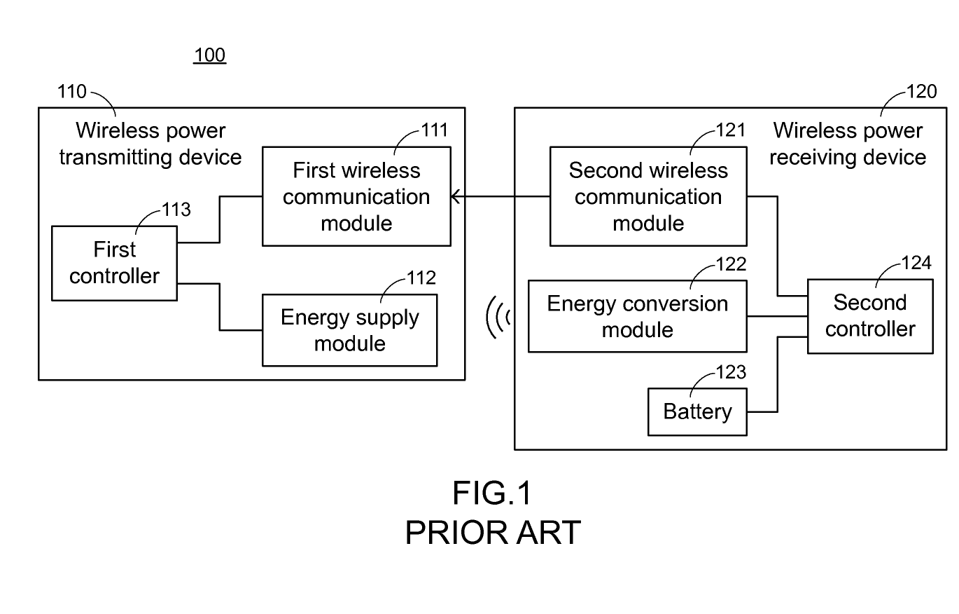

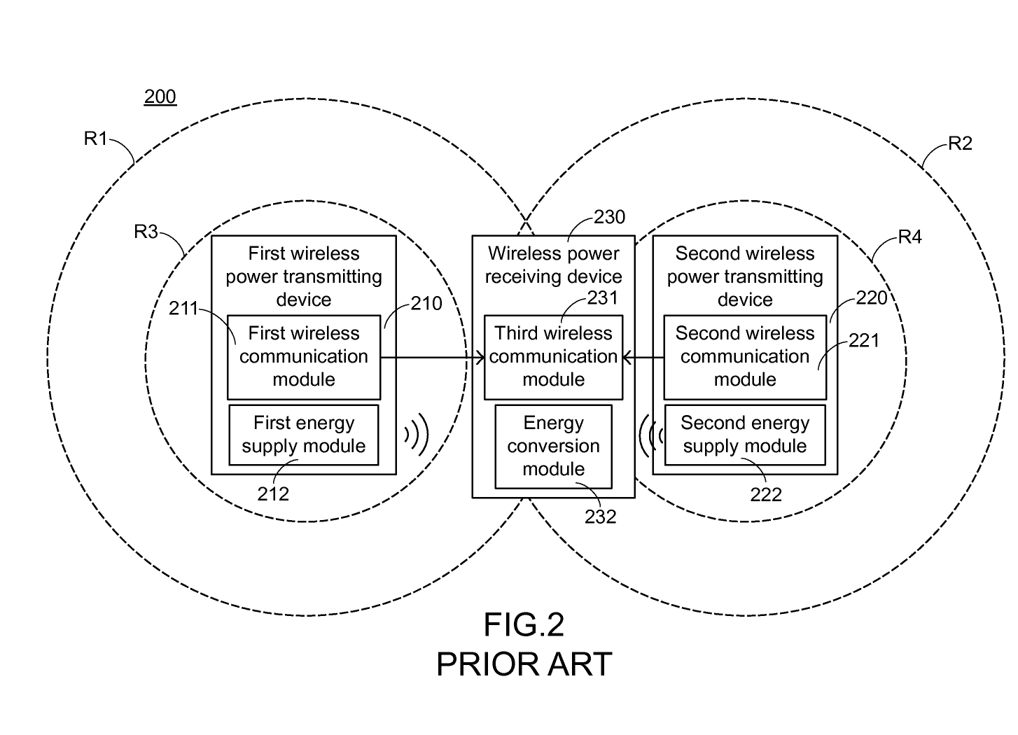

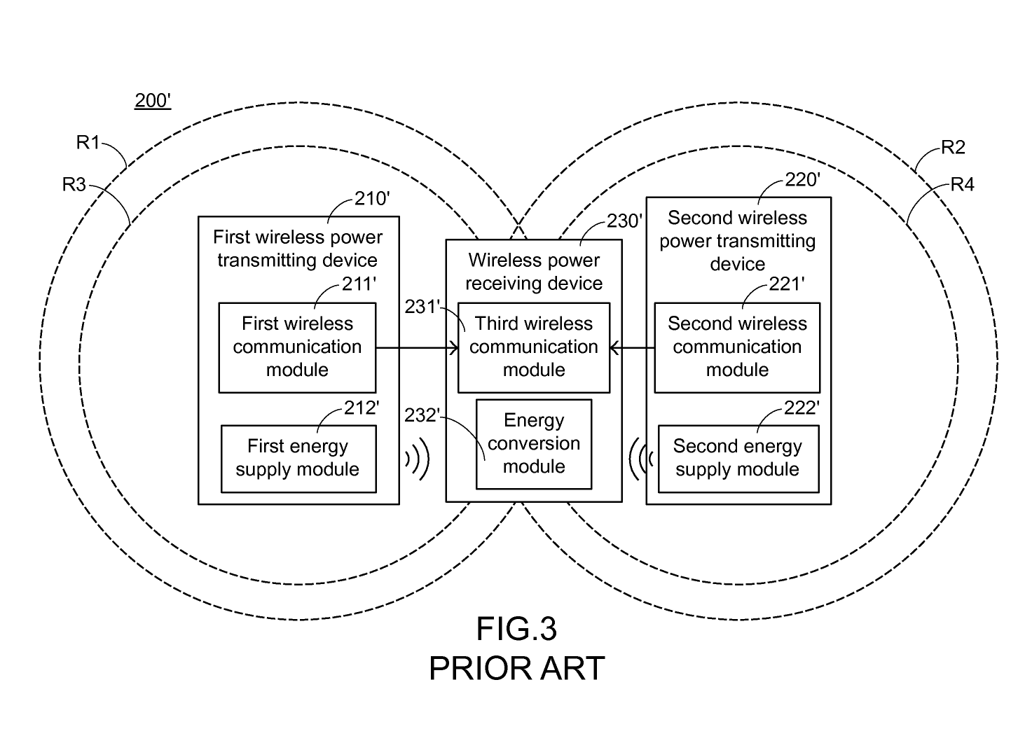

### DETAILED DESCRIPTION OF THE PREFERRED EMBODIMENT

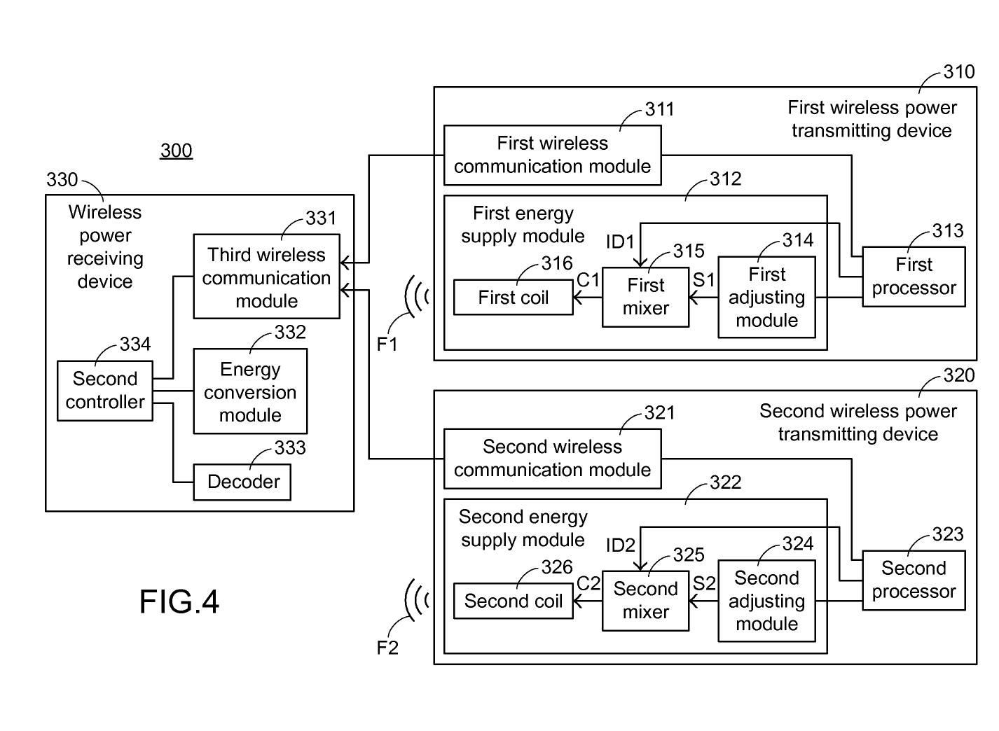

Hereinafter, a wireless charging system according to a first embodiment of the present invention will be illustrated with reference to FIG. 4. FIG. 4 is a schematic functional block diagram illustrating a wireless charging system according to a first embodiment of the present invention. As shown in FIG. 4, the wireless charging system 300 comprises plural wireless power transmitting devices and a wireless power receiving device 330. After the wireless power receiving device 330 is in wireless connection with any of the plural wireless power transmitting devices, the wireless power receiving device 330 may receive an energy field from the connected wireless power transmitting device. By receiving the energy field, the wireless power receiving device 330 may acquire electric power to perform a wireless charging task. For clarification and brevity, the plural wireless power transmitting devices of this embodiment comprise a first wireless power transmitting device 310 and a second wireless power transmitting device 320. It is noted that the number of the plural wireless power transmitting devices is not restricted. In another embodiment, the plural wireless power transmitting devices may comprise three or more wireless power transmitting devices.

An example of the wireless power receiving device 330 includes but is not limited to a smart phone, a notebook computer, a wireless earphone, a wireless mouse, a battery or a mobile power pack or any other appropriate electronic device. An example of each of the first wireless power transmitting device 310 and a second wireless power transmitting device 320 includes but is not limited to a charging board or any other widely-used wireless charger.

The first wireless power transmitting device 310 comprises a first wireless communication module 311, a first energy supply module 312 and a first processor 313. The first wireless communication module 311 and the first energy supply module 312 are electrically connected with the first processor 313. The first processor 313 may receive signals from the first wireless communication module 311 and the first energy supply module 312 and generate a first identification signal ID1 to the first energy supply module 312. The first identification signal ID1 is a high frequency signal or a signal containing a media access control (MAC) address of the first wireless communication module 311. The example of the first identification signal ID1 is not restricted. In this embodiment, the first identification signal ID1 is a high frequency containing the MAC address of the first wireless communication module 311.

The first wireless communication module 311 is used for transmitting and receiving a wireless signal. According to the wireless signal, a wireless connection between the first wireless power transmitting device 310 and the wireless power receiving device 330 is established. An example of the first wireless communication module 311 includes but is not limited to a known wireless communication module such as a Bluetooth communication module.

The first energy supply module 312 is used for generating a first energy field F1. By the first energy field F1, the wireless power receiving device 330 may be wirelessly charged. According to magnetic induction, magnetic resonance or any other appropriate wireless charging technology, the first energy supply module 312 may generate the first energy field F1. In this embodiment, the first energy supply module 312 generates the first energy field F1 according to the magnetic resonance.

The constituents and operating principles of the first energy supply module 312 will be illustrated as follows. In this embodiment, the first energy supply module 312 comprises a first adjusting module 314, a first mixer 315 and a first coil 316. The first adjusting module 314 is electrically connected with the first processor 313. The first mixer 315 is electrically connected with the first adjusting module 314 and the first processor 313. The first coil 316 is electrically connected with the first mixer 315.

The first adjusting module 314 may receive a direct current (DC) part of the first wireless power transmitting device 310 and convert the DC part into an alternating current (AC) part. Consequently, the first adjusting module 314 generates and issues a first transmitting signal S1 to the first mixer 315. In an embodiment, the first adjusting module 314 comprises an oscillator and a class-D amplifier. It is noted that the constituents of the first adjusting module 314 are not restricted. The method of converting the DC part into the AC part by the first adjusting module 314 are well known to those skilled in the art, and is not redundantly described herein.

The first mixer 315 may receive the first identification signal ID1 from the first processor 313 and the first transmitting signal S1 from the first adjusting module 314. When the first identification signal ID1 and the first transmitting signal S1 are received by the first mixer 315, the first identification signal ID1 is loaded into the first transmitting signal S1 by the first mixer 315, so that a first mixing signal C1 is generated. Then, the first mixing signal C1 is transmitted from the first mixer 315 to the first coil 316.

After the first mixing signal C1 is received, the first coil 316 generates the first energy field F1 according to the first mixing signal C1. Consequently, the first energy field F1 is not a pure energy. However, the first energy field F1 is an energy containing the first identification signal ID1. The method of generating the first energy field F1 by the first coil 316 is similar to the conventional method of generating the energy field by the conventional coil, and is not redundantly described herein.

The second wireless power transmitting device 320 comprises a second wireless communication module 321, a second energy supply module 322 and a second processor 323. The second wireless communication module 321 and the second energy supply module 322 are electrically connected with the second processor 323. The second processor 323 may receive signals from the second wireless communication module 321 and the second energy supply module 322 and generate a second identification signal ID2 to the second energy supply module 322. The second identification signal ID2 is a high frequency signal or a signal containing a MAC address of the second wireless communication module 321. The example of the second identification signal ID2 is not restricted. In this embodiment, the second identification signal ID2 is a high frequency signal containing the MAC address of the second wireless communication module 321.

The second wireless communication module 321 is used for transmitting and receiving a wireless signal. According to the wireless signal, a wireless connection between the second wireless power transmitting device 320 and the wireless power receiving device 330 is established. An example of the second wireless communication module 321 includes but is not limited to a known wireless communication module such as a Bluetooth communication module.

The second energy supply module 322 is used for generating a second energy field F2. By the second energy field F2, the wireless power receiving device 330 may be wirelessly charged. According to magnetic induction, magnetic resonance or any other appropriate wireless charging technology, the second energy supply module 322 may generate the second energy field F2. In this embodiment, the second energy supply module 322 generates the second energy field F2 according to the magnetic resonance.

The constituents and operating principles of the second energy supply module 322 will be illustrated as follows. In this embodiment, the second energy supply module 322 comprises a second adjusting module 324, a second mixer 325 and a second coil 326. The second adjusting module 324 is electrically connected with the second processor 323. The second mixer 325 is electrically connected with the second adjusting module 324 and the second processor 323. The second coil 326 is electrically connected with the second mixer 325.

The second adjusting module 324 may receive a direct current (DC) part of the second wireless power transmitting device 320 and convert the DC part into an alternating current (AC) part. Consequently, the second adjusting module 324 generates and issues a second transmitting signal S2 to the second mixer 325. In an embodiment, the second adjusting module 324 comprises an oscillator and a class-D amplifier. It is noted that the constituents of the second adjusting module 324 are not restricted. The method of converting the DC part into the AC part by the second adjusting module 324 are well known to those skilled in the art, and is not redundantly described herein.

The second mixer 325 may receive the second identification signal ID2 from the second processor 323 and the second transmitting signal S2 from the second adjusting module 324. When the second identification signal ID2 and the second transmitting signal S2 are received by the second mixer 325, the second identification signal ID2 is loaded into the second transmitting signal S2 by the second mixer 325, so that a second mixing signal C2 is generated. Then, the second mixing signal C2 is transmitted from the second mixer 325 to the second coil 326.

After the second mixing signal C2 is received, the second coil 326 generates the second energy field F2 according to the second mixing signal C2. Consequently, the second energy field F2 is not a pure energy. However, the second energy field F2 is an energy containing the second identification signal ID2. The method of generating the second energy field F2 by the second coil 326 is similar to the conventional method of generating the energy field by the conventional coil, and is not redundantly described herein.

The wireless power receiving device 330 comprises a third wireless communication module 331, an energy conversion module 332, a decoder 333 and a controller 334. The third wireless communication module 331, the energy conversion module 332 and the decoder 333 are electrically connected with the controller 334. Moreover, the decoder 333 is electrically connected with the energy conversion module 332. The controller 334 may receive signals from the third wireless communication module 331, the energy conversion module 332 and the decoder 333.

The third wireless communication module 331 is used for transmitting and receiving a wireless signal. According to the wireless signal, the wireless connection between the wireless power receiving device 330 and the first wireless power transmitting device 310 or the wireless connection between the wireless power receiving device 330 and the second wireless power transmitting device 320 is established. An example of the third wireless communication module 331 includes but is not limited to a known wireless communication module such as a Bluetooth communication module.

The energy conversion module 332 is used for receiving the energy field around the wireless power receiving device 330. The energy conversion module 332 may convert the energy field into electric power and issue the electric power to the controller 334. Moreover, after the energy field is transmitted from the energy conversion module 332 to the decoder 333, the identification signal may be decoded by the decoder 333. In an embodiment, the energy conversion module 332 comprises a coil, a rectifier circuit and a voltage reduction circuit. It is noted that the constituents of the energy conversion module 332 are not restricted. After the identification signal is decoded, the identification signal is transmitted from the decoder 333 to the controller 334.

The method of converting the energy field into a direct current by the energy conversion module 332 is similar to the conventional method of converting an energy field into a direct current, and the description thereof is omitted. Moreover, the energy conversion module 332 may receive the energy field according to magnetic induction, magnetic resonance or any other appropriate wireless charging technology. In an embodiment, the energy conversion module 332 receives the first energy field F1 and the second energy field F2 according to magnetic resonance. Moreover, the first energy supply module 312, the energy conversion module 332 and the energy conversion module 332 complies with a wireless charging standard. An example of the wireless charging standard includes but is not limited to a WPC (Wireless Power Consortium) protocol, a PMA (Power Matters Alliance) protocol, an A4WP (Alliance for Wireless Power) protocol or any other appropriate wireless charging standard.

For facilitating understanding the present invention, the wireless power receiving device 330 is located within the effective communication ranges (not shown) of the first wireless communication module 311 and the second wireless communication module 321. Moreover, the wireless power receiving device 330 is located within the effective power transmission range (not shown) of the second coil 326, but is not located within the effective power transmission range (not shown) of the first coil 316. In other words, the wireless power receiving device 330 can be in wireless connection with the second wireless power transmitting device 320 and receive the second energy field F2 from the second wireless power transmitting device 320. Moreover, although the wireless power receiving device 330 can be in wireless connection with the first wireless power transmitting device 310, the wireless power receiving device 330 cannot receive the first energy field F1 from the first wireless power transmitting device 310.

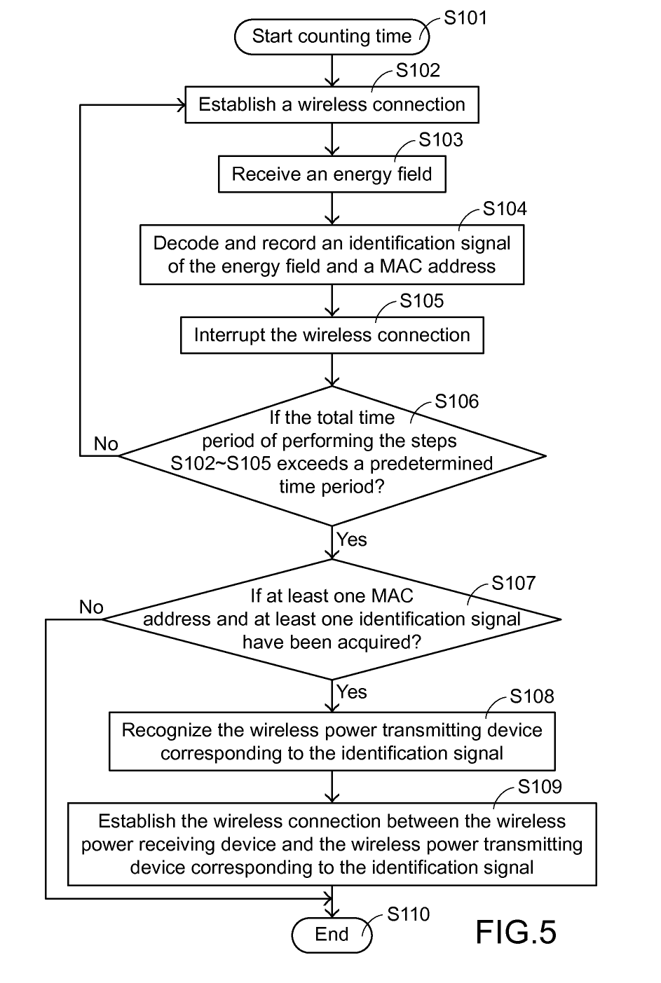

Hereinafter, a wireless charging method according to a first embodiment of the present invention will be illustrated with reference to FIG. 5. FIG. 5 is a flowchart of a wireless charging method according to the first embodiment of the present invention. As shown in FIG. 5, the wireless charging method comprises the following steps S101˜S110.

In the step S101, the wireless power receiving device 330 starts counting time.

In the step S102, the wireless power receiving device 330 is in wireless connection with each of the plural wireless power transmitting devices. After the wireless power receiving device 330 is in wireless connection with each of the plural wireless power transmitting devices, the first wireless power transmitting device 310 issues a first broadcasting signal and the second wireless power transmitting device 320 issues a second broadcasting signal.

For example, if the third wireless communication module 331 of the wireless power receiving device 330 receives the first broadcasting signal from the first wireless power transmitting device 310, the third wireless communication module 331 issues a broadcasting response signal to the first wireless power transmitting device 310. After the broadcasting response signal is received, the first wireless power transmitting device 310 issues a connection request signal to the wireless power receiving device 330. After the connection request signal is received by the wireless power receiving device 330, a connection response signal is transmitted back from the wireless power receiving device 330 to the first wireless power transmitting device 310. Meanwhile, the wireless power receiving device 330 is in wireless connection with the first wireless power transmitting device 310.

In the step S103, the wireless power receiving device 330 receives the energy field of the connected wireless power transmitting device. Since the wireless power receiving device 330 is in wireless connection with the first wireless power transmitting device 310, the energy conversion module 332 of the wireless power receiving device 330 receives the first energy field F1 from the first energy supply module 312 of the first wireless power transmitting device 310. However, as mentioned above, the wireless power receiving device 330 is not located within the effective power transmission range of the first coil 316. Consequently, the energy conversion module 332 of the wireless power receiving device 330 cannot receive the first energy field F1.

In the step S104, the wireless power receiving device 330 decodes the identification signal of the energy field and the MAC address of the broadcasting signal and records the identification signal of the energy field and the MAC address. As mentioned above, after the wireless power receiving device 330 decodes the first broadcasting signal of the first wireless power transmitting device 310, the MAC address of the first wireless power transmitting device 310 is acquired and recorded. Since the first energy field F1 is not received by the wireless power receiving device 330, the wireless power receiving device 330 cannot decode the first energy field F1. Under this circumstance, the first identification signal ID1 of the first energy field F1 is not acquired.

In the step S105, the wireless connection between the wireless power receiving device 330 and the first wireless power transmitting device 310 is interrupted by the wireless power receiving device 330.

In the step S106, the wireless power receiving device 330 judges whether the total time period of performing the steps S102˜S105 exceeds a predetermined time period. If the total time period of performing the steps S102˜S105 does not exceed the predetermined time period (e.g. 10 ms), the step S102 is performed. Whereas, if the total time period of performing the steps S102˜S105 exceeds the predetermined time period, the step S107 is performed.

For clarification, it is assumed that the wireless power receiving device 330 judges that the total time period of performing the steps S102˜S105 does not exceed the predetermined time period. Thus, the step S102 is performed. In the step S102, the wireless power receiving device 330 is in wireless connection with each of the plural wireless power transmitting devices and records the MAC address of the connected wireless power transmitting device. Similarly, after the wireless power receiving device 330 is in wireless connection with each of the plural wireless power transmitting devices, the first wireless power transmitting device 310 issues the first broadcasting signal and the second wireless power transmitting device 320 issues the second broadcasting signal.

For example, if the third wireless communication module 331 of the wireless power receiving device 330 receives the second broadcasting signal from the second wireless power transmitting device 320, the third wireless communication module 331 issues a broadcasting response signal to the second wireless power transmitting device 320. After the broadcasting response signal is received, the second wireless power transmitting device 320 issues a connection request signal to the wireless power receiving device 330. After the connection request signal is received by the wireless power receiving device 330, a connection response signal is transmitted back from the wireless power receiving device 330 to the second wireless power transmitting device 320. Meanwhile, the wireless power receiving device 330 is in wireless connection with the second wireless power transmitting device 320.

Then, in the step S103, the wireless power receiving device 330 receives the energy field of the connected wireless power transmitting device. Since the wireless power receiving device 330 is in wireless connection with the second wireless power transmitting device 320, the energy conversion module 332 of the wireless power receiving device 330 receives the second energy field F2 from the second energy supply module 322 of the second wireless power transmitting device 320.

Then, in the step S104, the wireless power receiving device 330 decodes the identification signal of the energy field and the MAC address of the broadcasting signal and records the identification signal of the energy field and the MAC address. Consequently, the wireless power receiving device 330 decodes the second broadcasting signal of the second wireless power transmitting device 320. After the second broadcasting signal is decoded, the MAC address of the second wireless power transmitting device 320 is acquired and recorded. Moreover, after the wireless power receiving device 330 decodes the identification signal of the second energy field F2, the second identification signal ID2 of the second energy field F2 is acquired and recorded.

Then, in the step S105, the wireless connection between the wireless power receiving device 330 and the second wireless power transmitting device 320 is interrupted by the wireless power receiving device 330.

Then, in the step S106, the wireless power receiving device 330 judges whether the total time period of performing the steps S102˜S105 exceeds a predetermined time period. If the total time period of performing the steps S102˜S105 does not exceed the predetermined time period (e.g. 10 ms), the step S102 is performed. If the plural wireless power transmitting devices further comprise a third wireless power transmitting device (not shown) and the wireless power receiving device 330 is located within an effective communication range of the third wireless power transmitting device, the wireless power receiving device 330 receives a third broadcasting signal from the third wireless power transmitting device and is in wireless communication with the third wireless power transmitting device. Whereas, if the total time period of performing the steps S102˜S105 exceeds the predetermined time period, the step S107 is performed.

For clarification, it is assumed that the wireless power receiving device 330 judges that the total time period of performing the steps S102˜S105 exceeds the predetermined time period. Thus, the step S107 is performed.

In the step S107, the controller 334 of the wireless power receiving device 330 judges whether at least one MAC address and at least one identification signal have been acquired. If the judging condition of the step S107 is satisfied, the step S108 is performed. If the judging condition of the step S107 is not satisfied, the step S110 is performed and thus the flowchart is ended. Since the MAC address of the first wireless power transmitting device 310 and the MAC address and the second identification signal ID2 of the second energy field F2 of the second wireless power transmitting device 320 have been acquired by the wireless power receiving device 330, the step S108 is performed.

In the step S108, the wireless power receiving device 330 recognizes the wireless power transmitting device corresponding to the identification signal according to the received MAC addresses and the received identification signal.

As mentioned above, the wireless power receiving device 330 has recorded the first MAC address of the first wireless power transmitting device 310 and the second MAC address of the second wireless power transmitting device 320 and received the second identification signal ID2 of the second energy field F2. In this embodiment, the content of the second identification signal ID2 is the second MAC address of the second wireless power transmitting device 320. Consequently, after the controller 334 analyzes all MAC addresses and all identification signals, the controller 334 judges that the second identification signal ID2 of the second energy field F2 is identical to the second MAC address of the second wireless power transmitting device 320. Under this circumstance, the wireless power receiving device 330 recognizes that the wireless power transmitting device corresponding to the second identification signal ID2 is the second wireless power transmitting device 320.

In the step S109, the wireless connection between the wireless power receiving device 330 and the wireless power transmitting device corresponding to the identification signal is established. Consequently, the third wireless communication module 331 of the wireless power receiving device 330 issues a broadcasting response signal to the wireless power transmitting device corresponding to the identification signal (i.e. the second wireless power transmitting device 320). Meanwhile, the wireless power receiving device 330 is in wireless connection with the second wireless power transmitting device 320. After the wireless power receiving device 330 is in wireless connection with the second wireless power transmitting device 320, the wireless power receiving device 330 allows the energy conversion module 322 to convert the second energy field F2 into electric power. The electric power is transmitted to other components of the wireless power receiving device 330 (e.g. a charger or other power-consumption components). Consequently, the wireless charging task of the wireless power receiving device 330 is started.

In the step S110, the flowchart is ended.

In the first embodiment of the present invention, the wireless power receiving device 330 is located within the effective power transmission range R4 of the second wireless power transmitting device 320, but is not located within the effective power transmission range R3 of the first wireless power transmitting device 310. Consequently, according to the received MAC address and the received identification signal, the wireless power receiving device 330 recognizes the wireless power transmitting device corresponding to the identification signal. Moreover, the wireless power receiving device 330 recognizes the second wireless power transmitting device 320 as the suitable wireless power transmitting device and receives the energy field from the corresponding wireless power transmitting device. Consequently, the wireless charging task of the wireless power receiving device 330 is performed.

However, if the wireless power receiving device 330 is located within both of the effective power transmission range R3 of the first wireless power transmitting device 310 and the effective communication range R4 of the second wireless power transmitting device 320, the wireless power receiving device 330 of this embodiment still fails to accurately judge whether the suitable wireless power transmitting device is the first wireless power transmitting device 310 or the second wireless power transmitting device 320. For solving this drawback, the present invention further provides a second embodiment.

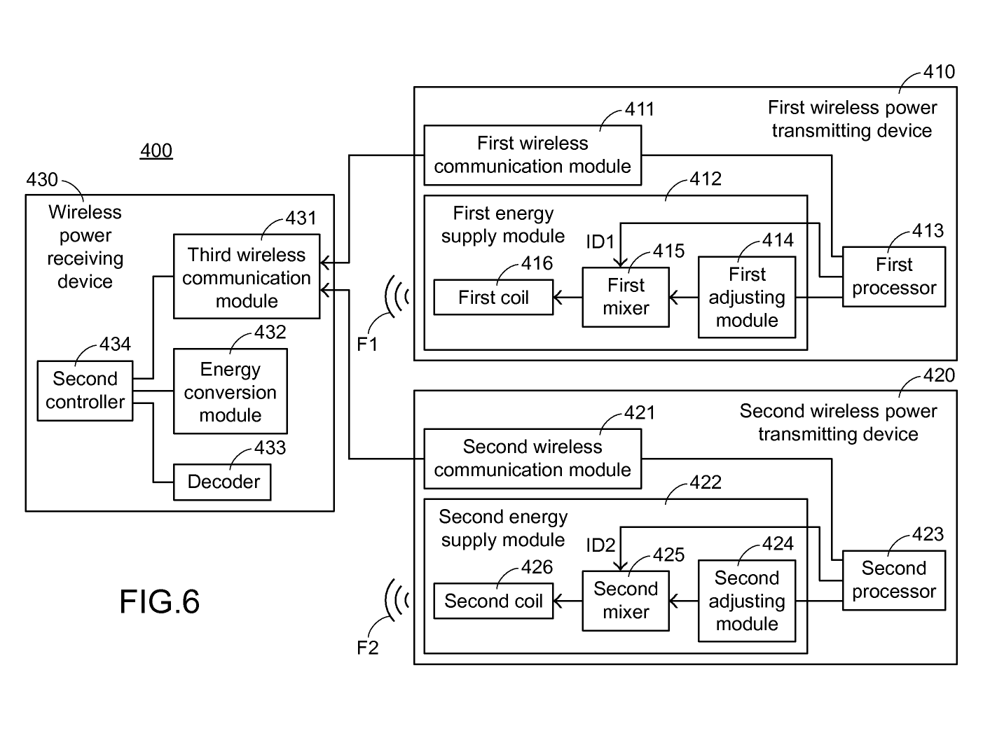

FIG. 6 is a schematic functional block diagram illustrating a wireless charging system according to a second embodiment of the present invention. As shown in FIG. 6, the wireless charging system 400 comprises plural wireless power transmitting devices and a wireless power receiving device 430. The plural wireless power transmitting devices of this embodiment comprise a first wireless power transmitting device 410 and a second wireless power transmitting device 420.

The first wireless power transmitting device 410 comprises a first wireless communication module 411, a first energy supply module 412 and a first processor 413. The first processor 413 may receive signals from the first wireless communication module 411 and the first energy supply module 412 and generate a first identification signal ID1 to the first energy supply module 412. The first energy supply module 412 is used for generating a first energy field F1. The first energy field F1 contains the first identification signal ID1.

The second wireless power transmitting device 420 comprises a second wireless communication module 421, a second energy supply module 422 and a second processor 423. The second processor 423 may receive signals from the second wireless communication module 421 and the second energy supply module 422 and generate a second identification signal ID2 to the second energy supply module 422. The second energy supply module 422 is used for generating a second energy field F2. The second energy field F2 contains the second identification signal ID2.

The wireless power receiving device 430 comprises a third wireless communication module 431, an energy conversion module 432, a decoder 433 and a controller 434. The third wireless communication module 431 is used for transmitting and receiving a wireless signal. The energy conversion module 432 may convert the energy field into electric power and issue the electric power to the controller 434. Moreover, after the energy field is transmitted from the energy conversion module 432 to the decoder 433, the identification signal may be decoded by the decoder 433. After the identification signal is decoded, the identification signal is transmitted from the decoder 433 to the controller 434.

In comparison with the wireless charging system of the first embodiment as shown in FIG. 4, the distance between the wireless power receiving device 430 and the first wireless power transmitting device 410 is distinguished and the controller 434 further judges the power consumption amount of each energy field.

In this embodiment, the distance between the wireless power receiving device 430 and the first wireless power transmitting device 410 is reduced. Consequently, the wireless power receiving device 430 is located within the effective communication range of the first wireless communication module 411 and the effective communication range of the second wireless communication module 421, and the wireless power receiving device 430 is located within the effective power transmission range of the first coil 416 and the effective power transmission range of the second coil 426.

However, a first distance between the wireless power receiving device 430 and the first wireless power transmitting device 410 is still longer than a second distance between the wireless power receiving device 430 and the second wireless power transmitting device 420. Consequently, a power supply efficiency of the first wireless power transmitting device 410 is lower than the power supply efficiency of the second wireless power transmitting device 420. In other words, the power consumption amount of the first wireless power transmitting device 410 is larger than the power consumption amount of the second wireless power transmitting device 420.

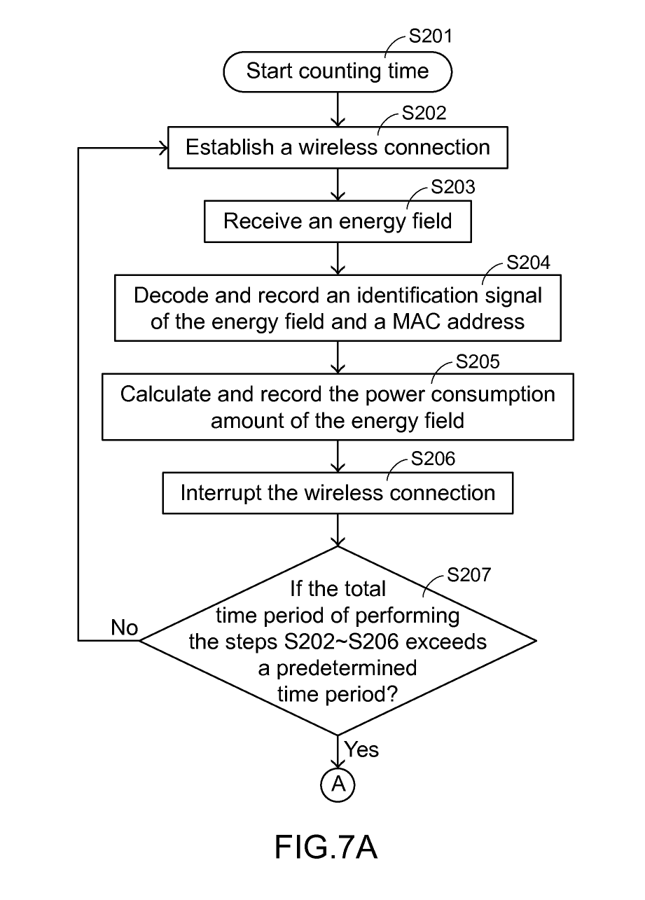

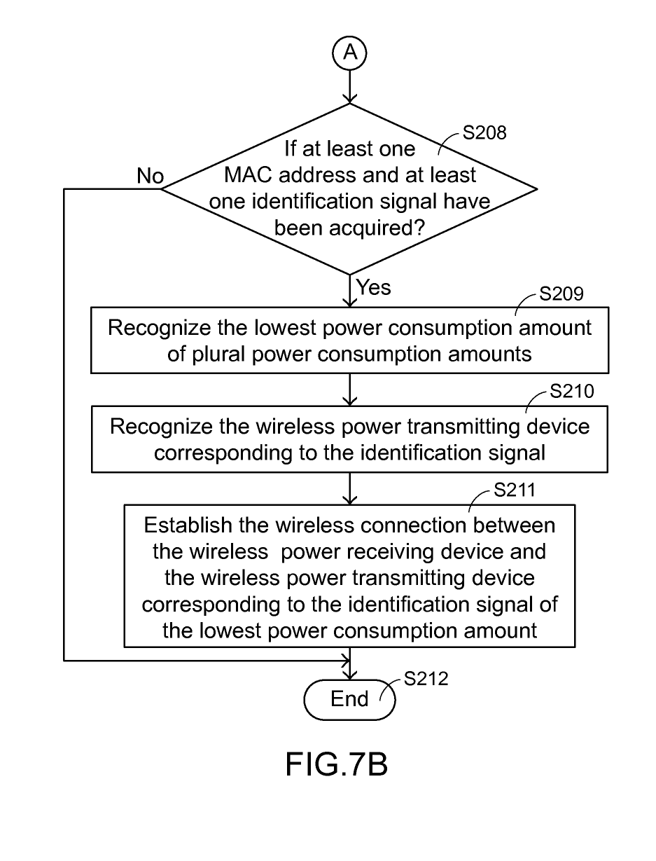

Hereinafter, a wireless charging method according to a second embodiment of the present invention will be illustrated with reference to FIGS. 7A and 7B. FIGS. 7A and 7B are a flowchart of a wireless charging method according to the second embodiment of the present invention. As shown in FIGS. 7A and 7B, the wireless charging method comprises the following steps S201˜S212.

In the step S201, the wireless power receiving device 430 starts counting time.

In the step S202, the wireless power receiving device 430 is in wireless connection with each of the plural wireless power transmitting devices. For example, the wireless power receiving device 430 is in wireless connection with the first wireless power transmitting device 410 to receive a wireless communication signal from the first wireless power transmitting device 410. The contents of the wireless communication signal from the first wireless power transmitting device 410 contains a MAC address of the first wireless power transmitting device 410 and an original power supply information of the first wireless power transmitting device 410.

In the step S203, the wireless power receiving device 430 receives the energy field of the connected wireless power transmitting device. Consequently, the energy conversion module 432 of the wireless power receiving device 430 receives a first energy field F1 from the first energy supply module 412 of the first wireless power transmitting device 410.

In the step S204, the wireless power receiving device 430 decodes the identification signal of the energy field and the MAC address of the broadcasting signal and records the identification signal of the energy field and the MAC address. Consequently, the wireless power receiving device 430 decodes the first broadcasting signal of the first wireless power transmitting device 410. Meanwhile, the MAC address of the first wireless power transmitting device 410 is acquired and recorded. Moreover, after the first energy field F1 is decoded, a first identification signal ID1 of the first energy field F1 is acquired and recorded by the wireless power receiving device 430.

In the step S205, the wireless power receiving device 430 calculates and records the power consumption amount of the energy field. That is, the controller 434 of the wireless power receiving device 430 calculates and records the power consumption amount of the first energy field F1. Firstly, according to the wireless communication signal from the first wireless power transmitting device 410, the wireless power receiving device 430 acquires the original power supply information of the first wireless power transmitting device 410. Then, the electric quantity obtained through the energy conversion by the energy conversion module 432 is detected by the controller 434 of the wireless power receiving device 430. In addition, according to the quantity of the electric power obtained through the conversion of the original power supply information of the first wireless power transmitting device 410 by the energy conversion module 432, the power consumption amount of the first energy field F1 is calculated by the controller 434 of the wireless power receiving device 430. For example, the power consumption amount of the first energy field F1 is 30%.

In the step S206, the wireless connection between the wireless power receiving device 430 and the first wireless power transmitting device 410 is interrupted.

In the step S207, the wireless power receiving device 430 judges whether the total time period of performing the steps S202-S206 exceeds a predetermined time period. If the total time period of performing the steps S202-S206 does not exceed the predetermined time period (e.g. 10 ms), the step S202 is performed. Whereas, if the total time period of performing the steps S202˜S206 exceeds the predetermined time period, the step S208 is performed.

For clarification, it is assumed that the wireless power receiving device 430 judges that the total time period of performing the steps S202˜S206 does not exceed the predetermined time period. Thus, the step S202 is performed. In the step S202, the wireless power receiving device 430 is in wireless connection with the second wireless power transmitting device 420.

Then, in the step S203, the wireless power receiving device 430 receives the energy field of the connected wireless power transmitting device. Since the wireless power receiving device 430 is in wireless connection with the second wireless power transmitting device 420, the energy conversion module 432 of the wireless power receiving device 430 receives a second energy field F2 from the second energy supply module 422 of the second wireless power transmitting device 420.

Then, in the step S204, the wireless power receiving device 430 decodes the identification signal of the energy field and the MAC address of the broadcasting signal and records the identification signal of the energy field and the MAC address. Consequently, the wireless power receiving device 430 decodes the second broadcasting signal of the second wireless power transmitting device 420. After the second broadcasting signal is decoded, the MAC address of the second wireless power transmitting device 420 is acquired and recorded. Moreover, after the wireless power receiving device 430 decodes the identification signal of the second energy field F2, a second identification signal ID2 of the second energy field F2 is acquired and recorded.

In the step S205, the wireless power receiving device 430 calculates and records the power consumption amount of the energy field. That is, the controller 434 of the wireless power receiving device 430 calculates and records the power consumption amount of the second energy field F2. Since the first distance between the wireless power receiving device 430 and the first wireless power transmitting device 410 is longer than the second distance between the wireless power receiving device 430 and the second wireless power transmitting device 420, the power consumption amount of the first energy field F1 is larger than the power consumption amount of the second energy field F2. For example, the power consumption amount of the second energy field F2 is 10%.

In the step S206, the wireless connection between the wireless power receiving device 430 and the second wireless power transmitting device 420 is interrupted by the wireless power receiving device 430.

In the step S207, the wireless power receiving device 430 judges whether the total time period of performing the steps S202˜S206 exceeds the predetermined time period. If the total time period of performing the steps S202˜S206 does not exceed the predetermined time period (e.g. 10 ms), the step S202 is performed. Whereas, if the total time period of performing the steps S202˜S206 exceeds the predetermined time period, the step S208 is performed.

For clarification, it is assumed that the wireless power receiving device 430 judges that the total time period of performing the steps S202˜S206 exceeds the predetermined time period. Thus, the step S208 is performed.

In the step S208, the wireless power receiving device 430 judges whether at least one MAC address and at least one identification signal have been acquired. If the controller 434 of the wireless power receiving device 430 judges that at least one MAC address and at least one identification signal have been acquired, the step S209 is performed. If the judging condition of the step S208 is not satisfied, the step S212 is performed and thus the flowchart is ended. Since the MAC addresses of the first wireless power transmitting device 410 and the second wireless power transmitting device 420 and the first identification signal ID1 of the first energy field F1 of the first wireless power transmitting device 410 and the second identification signal ID2 of the second energy field F2 of the second wireless power transmitting device 420 have been acquired by the wireless power receiving device 430, the step S209 is performed.

In the step S209, the wireless power receiving device 430 recognizes the lowest power consumption amount of plural power consumption amounts. Since the power consumption amount of the first energy field F1 is 30% and the power consumption amount of the second energy field F2 is 10%, the lowest power consumption amount is the power consumption amount of the second energy field F2 (i.e. 10%).

In the step S210, the wireless power receiving device 430 recognizes the wireless power transmitting device corresponding to the identification signal according to the received MAC addresses and the received identification signals. As mentioned above, the wireless power receiving device 430 has recorded the first MAC address of the first wireless power transmitting device 410 and the second MAC address of the second wireless power transmitting device 420 and received the first identification signal ID1 of the first energy field F1 and the second identification signal ID2 of the second energy field F2.

In this embodiment, the content of the first identification signal ID1 is identical to the first MAC address of the first wireless power transmitting device 410, and the content of the second identification signal ID2 is identical to the second MAC address of the second wireless power transmitting device 420. Consequently, after the controller 434 analyzes all MAC addresses and all identification signals, the controller 434 judges that the first identification signal ID1 of the first energy field F1 is identical to the first MAC address of the first wireless power transmitting device 410 and the second identification signal ID2 of the second energy field F2 is identical to the second MAC address of the second wireless power transmitting device 420. Under this circumstance, the wireless power receiving device 430 recognizes that the wireless power transmitting device corresponding to the first identification signal ID1 is the first wireless power transmitting device 410 and the wireless power transmitting device corresponding to the second identification signal ID2 is the second wireless power transmitting device 420.

In the step S211, the wireless power receiving device 430 is in wireless connection with the wireless power transmitting device corresponding to the identification signal of the lowest power consumption amount. Consequently, the third wireless communication module 431 of the wireless power receiving device 430 issues a broadcasting response signal to the wireless power transmitting device corresponding to the identification signal of the lowest power consumption amount (i.e. the second wireless power transmitting device 420). Meanwhile, the wireless power receiving device 430 is in wireless connection with the second wireless power transmitting device 420. After the wireless power receiving device 430 is in wireless connection with the second wireless power transmitting device 420, the wireless power receiving device 430 allows the energy conversion module 422 to convert the second energy field F2 into electric power. The electric power is transmitted to other components of the wireless power receiving device 430 (e.g. a charger or other power-consumption components). Consequently, the wireless charging task of the wireless power receiving device 430 is started.

In the step S212, the flowchart is ended.

From the above descriptions, the present invention provides a wireless charging method, a wireless power receiving device and a wireless charging system. An identification signal is added to an energy field. Moreover, the energy field is recognized according to the identification signal of the energy field. Consequently, the wireless power receiving device selects the most appropriate energy field to perform the wireless charging task. Under this circumstance, the wireless power receiving device is not in wireless connection with the inappropriate wireless power transmitting device. Consequently, the wireless charging efficiency of the wireless power receiving device is further enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A wireless charging method, comprising:
allowing a wireless power receiving device to be in wireless connection with plural wireless power transmitting devices sequentially;
receiving energy fields from the plural wireless power transmitting devices, wherein the energy fields contain plural identification signals, respectively;
decoding the plural identification signals;
calculating plural power consumption amounts of the corresponding energy fields;
recoding the plural identification signals corresponding to the energy fields and the plural power consumption amounts;
recognizing the lowest power consumption amount of the plural power consumption amounts; and
allowing the wireless power receiving device to be in wireless connection with the wireless power receiving device corresponding to the lowest power consumption amount according to the identification signal corresponding to the lowest power consumption amount, so that the wireless power receiving device is wirelessly charged by the wireless power transmitting device corresponding to the lowest power consumption amount.

2. The wireless charging method according to claim 1, wherein the identification signal is a high frequency signal or a media access control address of the corresponding wireless power transmitting device.

3. A wireless power receiving device, comprising:
a wireless communication module in wireless connection with plural wireless power transmitting devices sequentially;
an energy conversion module receiving energy fields from the plural wireless power transmitting devices, wherein the energy fields contain plural identification signals, respectively;
a decoder decoding the plural identification signals; and
a controller calculating plural power consumption amounts of the corresponding energy fields, recognizing the lowest power consumption amount of the plural power consumption amounts, and allowing the wireless communication module to be in wireless connection with the wireless power transmitting device corresponding to the lowest power consumption amount according to the identification signal corresponding to the lowest power consumption amount, so that the wireless power receiving device is wirelessly charged by the wireless power transmitting device corresponding to the lowest power consumption amount.

4. The wireless power receiving device according to claim 3, wherein the wireless communication module is a Bluetooth communication module.

5. The wireless power receiving device according to claim 3, wherein the identification signal is a high frequency signal or a media access control address of the corresponding wireless power transmitting device.

6. A wireless power system, comprising:
plural wireless power transmitting devices comprising plural first wireless communication modules and plural energy supply modules, respectively, wherein the first wireless communication modules generate plural wireless communication signals, respectively, and the plural energy supply modules generate plural energy fields, respectively, wherein the energy fields contain plural identification signals, respectively; and
a wireless power receiving device comprising:
a second wireless communication module receiving the plural wireless communication signals, wherein the second wireless communication module is in wireless connection with plural wireless power transmitting devices sequentially according to the plural wireless communication signals;
an energy conversion module receiving the energy fields from the plural wireless power transmitting devices;
a decoder decoding the plural identification signals; and
a controller recognizing the plural wireless power transmitting devices corresponding to the plural identification signals and allowing the second wireless communication module to be in wireless connection with the first wireless communication module of each wireless power transmitting device, so that the wireless power receiving device is wirelessly charged.

7. The wireless charging system according to claim 6, wherein the controller further calculates plural power consumption amounts of the corresponding energy fields, recognizes the lowest power consumption amount of the plural power consumption amounts, and allows the second wireless communication module to be in wireless connection with the wireless power transmitting device corresponding to the lowest power consumption amount according to the identification signal corresponding to the lowest power consumption amount, so that the wireless power receiving device is wirelessly charged by the wireless power transmitting device corresponding to the lowest power consumption amount.

8. The wireless charging system according to claim 7, wherein each of the plural wireless communication signals contains an original power supply information, and the controller calculates the power consumption amount of the corresponding energy field according to an electric quantity obtained through conversion by the energy conversion module and the original power supply information.

9. The wireless charging system according to claim 6, wherein the first wireless communication modules and the second wireless communication modules are Bluetooth communication modules.

10. The wireless charging system according to claim 6, wherein the identification signal is a high frequency signal or a media access control address of the corresponding first wireless communication module.

11. The wireless charging system according to claim 6, wherein each of the plural wireless power transmitting devices comprises a processor, wherein the processor generates the corresponding identification signal.

12. The wireless charging system according to claim 6, wherein each of the energy supply modules of the plural wireless power transmitting devices comprises a mixer, wherein after the mixer loads the corresponding identification signal into a transmitting signal, a mixing signal is generated, wherein the energy field is generated according to the mixing signal.
